(19) United States
(12) Patent Application Publication
(10) Pub. No.: US 2008/0185350 A1
(43) Pub. Date: Aug. 7, 2008

(54) METHOD AND APPARATUS FOR SEPARATING OIL SAND PARTICULATES FROM A THREE-PHASE STREAM

(75) Inventors: Darius Simon John Remesat, Calgary (CA); Michael Siconolfi, St. Catharines (CA)

Correspondence Address: HOVEY WILLIAMS LLP, 10801 Mastin Blvd., Suite 1000, Overland Park, KS, 66210, US

(73) Assignee: KOCH-GLITSCH, LP, Wichita, KS (US)

(21) Appl. No.: 11/671,315

(22) Filed: Feb. 5, 2007

(51) Int. Cl. B01D 43/00

(52) U.S. Cl. 210/774; 210/767

(57) ABSTRACT

A method and apparatus for removing solid particles from a three-phase stream that utilizes a separation vessel comprising a vapor-liquid separation zone and an overlying vapor-solid separation zone. The vapor-solid separation zone can comprise a solids flow inhibiting structure operable to remove at least a portion of the solid particles in the vapor stream. In one embodiment, the solids flow inhibiting structure comprises at least one packed section and/or at least one spray nozzle operable to wet at least a portion of the packing. In another embodiment, the cross-sectional flow area of the vapor-solid separation zone can be smaller than the cross-sectional flow area of the vapor-liquid separation zone.

### BACKGROUND OF THE INVENTION

The present invention generally relates to a method and apparatus for separating solid particles from a three-phase stream. In another aspect, the present invention relates to a method and apparatus for removing oil sand tailings particulates from a three-phase hydrocarbon-containing stream in an oil sand processing facility.

Oil sand deposits, also referred to as tar sands or bituminous sands, are naturally occurring geological formations that have the potential to yield significant amounts of petroleum. Oil sand deposits are made up of porous sand and clay particles surrounded by a relatively viscous, tar-like substance called bitumen. The heavy hydrocarbon molecules in bitumen can be thermally and/or catalytically cracked to produce a lighter “synthetic crude oil” (i.e., “syncrude”), which can subsequently be refined by traditional methods into petroleum products such as gasoline, diesel, kerosene, and the like. Oil sand deposits are projected to become a major source of oil, especially in light of the declining conventional crude oil reserves. Globally, oil sand deposits have been estimated to contain up to 2 trillion potential barrels of oil. Approximately 85 percent of the known potential reserves exist in the two largest oil sand deposits located in Alberta, Canada and Venezuela In order to recover the bituminous petroleum from oil sand deposits, processing facilities have been established to mine the oil sand, extract the hydrocarbon from the sand, and upgrade the resulting bituminous material into syncrude and other useable petroleum products that can be further refined and/or sold.

During the process of extracting oil from the sand, aqueous waste streams are generated that include relatively high particulate concentrations. These particles of sand, clay, silica, silt, asphaltenes, and the like (i.e., oil sand tailings) are routed to a settling basin, or tailings pond, wherein the solid particles settle out of the liquid phase. Often, this liquid phase comprises a considerable quantity of recoverable bitumen and other petroleum material. In order to reclaim this residual hydrocarbon, oil sand processing facilities typically include a tailings solvent recovery unit (TSRU), which utilizes a series of heat exchangers and flash drums to separate the hydrocarbon from the particulate-containing water stream. Typically, a substantial portion of the tailings particulates remains in the recovered hydrocarbon stream after separation, which causes severe erosion to and fouling in downstream piping and equipment. Equipment subjected to severe erosion and fouling requires more frequent maintenance and replacement, which causes increased downtime and operational expenses.

Thus, a need exists for a robust system for separating hydrocarbon material from a stream containing oil sand particulates in a way that efficiently minimizes particle carryover in order to extend equipment maintenance intervals and reduce operating expenses. Advantageously, the system will be simple and easily adaptable to both new and existing facilities.

### BRIEF SUMMARY OF THE INVENTION

In one aspect, the present invention provides a method including heating a two-phase stream comprising a liquid and a plurality of solid particles to thereby produce a three-phase stream having a vapor fraction greater than about 0.5, on a weight basis based on the total weight of the stream. The method includes separating the three-phase stream into a predominantly vapor stream and a predominantly liquid stream by using a separation vessel having a vapor-solid separation zone and an underlying vapor-liquid separation zone. The three-phase feed stream discharges through a feed inlet into the vapor-liquid separation zone, and a vapor stream comprising solid particles passes through a solids flow inhibiting structure in the vapor-solid separation zone. In one embodiment, the solids flow inhibiting structure comprises one or more sections of structured packing and a plurality of spray nozzles located above and below the packing sections that are operable to wet at least a portion of the packing. In another embodiment, the cross-sectional flow area of the vapor-solid separation zone can be smaller than the cross-sectional flow area of the vapor-liquid separation zone.

### BRIEF DESCRIPTION OF THE DRAWINGS

In the accompanying drawings that form part of the specification and are to be read in conjunction therewith, and in which like reference numerals are used to indicate like parts in the various views:

FIG. 1 is a schematic depiction of an oil sand processing facility in accordance with one embodiment of the present invention, particularly illustrating the location of a tailings solvent recovery (TSRU) flash drum within the oil sands processing facility;

FIG. 2 is a schematic depiction of a TSRU flash drum in accordance with one embodiment of the present invention;

FIG. 3 is a sectional view of the TSRU flash drum of FIG. 2, taken along line 3-3 in FIG. 2; and

FIG. 4 is a sectional view of the TSRU flash drum of FIG. 2, taken along line 4-4 in FIG. 2.

### DETAILED DESCRIPTION OF THE INVENTION

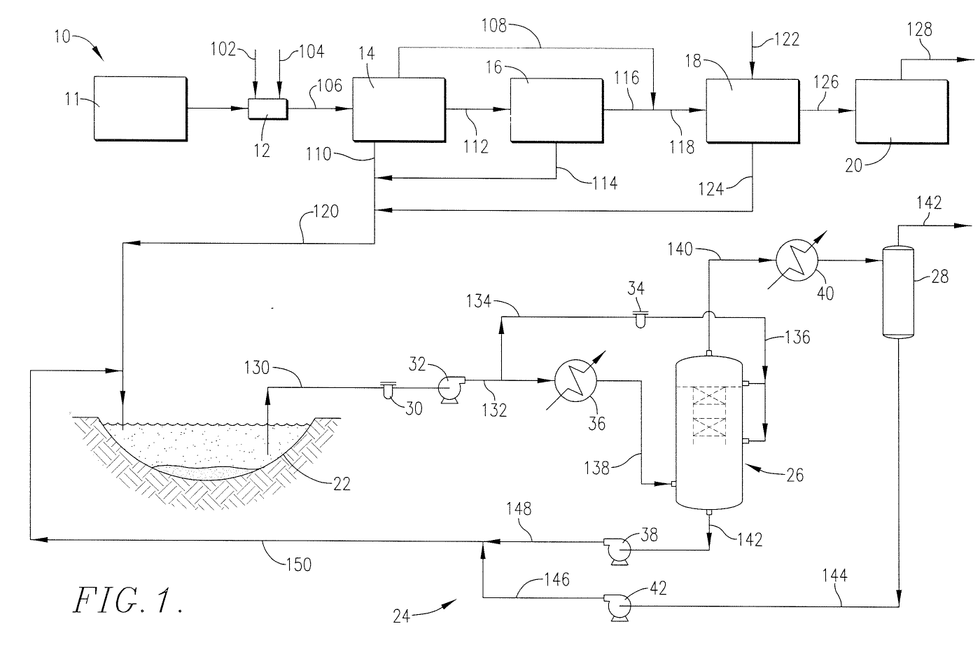

Referring to the drawings in more detail and initially to FIG. 1, one embodiment of an oil sand processing facility is designated generally by the numeral 10 and includes an oil sand mine site 11 from which oil sands are mined using conventional processes. The oil sand mined from site 11 can contain porous sand and clay particles surrounded by viscous, tar-like bitumen. Oil sand extracted from mine site 11 is subsequently processed in a conditioning unit 12 prior to entering first and second extraction units 14 and 16, wherein the bitumen is separated from the sand and other particulates. The bituminous product is processed in a froth treatment unit 18 before being converted to syncrude and other petroleum products in an upgrader 20. The aqueous tailings waste streams exiting first and second extraction units 14 and 16 and froth treatment unit 18 can be routed to a tailings pond 22. Subsequently, a slipstream may be withdraw from tailings pond 22 and undergo processing in a tailings solvent recovery unit (TSRU) 24 in order to recover residual bitumen and other hydrocarbon components from the waste stream.

Referring again to FIG. 1, oil sand from mine site 11 having in the range of from about 1 to about 25, about 1.5 to about 18, or 2 to 15 weight percent bitumen based on the total weight of the stream, is routed to conditioning unit 12, wherein it is converted to slurry through the addition of caustic and hot water via respective conduits 102 and 104. In one embodiment, conditioning unit 12 can be located at the same location as mine site 11 and the oil sand slurry can be transported to first extraction unit 14 via hydrotransport. In another embodiment illustrated in FIG. 1, conditioning unit 12 can be located at a different location than mine site 11 and can receive the mined oil sand via truck, rail, or other conventional transportation means.

As illustrated by the embodiment shown in FIG. 1, the oil sand slurry can be transported from conditioning unit 12 to first extraction unit 14 via conduit 106. First extraction unit 14 can employ a separation vessel (not shown) to separate the slurry into three phases. A phase comprising predominantly bitumen and other hydrocarbon components forms at the top of the separation vessel. This phase, also referred to as the “froth,” can exit first extraction unit 14 via conduit 108. A second “tailings” phase comprising water, particulates, and some residual non-buoyant bitumen settles to the bottom of the separation vessel and exits first extraction unit 14 via conduit 110. A third phase, also referred to as the “middlings,” comprising water, sand, clay, and bitumen is routed via conduit 112 to second extraction unit 16, wherein it is subjected to another stage of separation. Typically, the second extraction unit 16 includes a separation process employing aeration to thereby produce secondary froth and tailings phases. The secondary tailings phase exits second extraction unit 16 via conduit 114 and thereafter combines with the tailings phase exiting first extraction unit 14 in conduit 110. The combined tailings stream in conduit 120 can then be routed to tailings pond 22, wherein at least a portion of the entrained particles can settle to the bottom of the pond. The secondary froth phase exits second extraction unit 16 via conduit 116 and combines with the froth phase exiting first extraction unit 14 in conduit 108. The combined bituminous froth stream in conduit 118 can then enter froth processing unit 18.

Froth processing unit 18 prepares the bitumen for subsequent upgrading by removing residual water and solids and by adding a lighter hydrocarbon containing solvent to improve the flow characteristics of the viscous bitumen stream. As illustrated in FIG. 1, the solvent stream enters froth processing unit 18 via conduit 122. In general, the solvent can comprise hydrocarbon, and, in one embodiment, can comprise hydrocarbon having a lower boiling point (i.e., lower molecular weight) than bitumen, such as, for example, naphtha. Froth processing unit 18 also employs a process to remove residual solid particles from the bituminous froth. For example, a centrifuge and/or inclined plate settler (IPS) may be used to produce a final froth stream and a final tailings stream. The final tailings stream exits froth processing unit 18 via conduit 124 and can thereafter be combined with the tailings stream in conduit 120 prior to being routed to tailings pond 22. The final bituminous froth product can be routed via conduit 126 to upgrader 20. In one embodiment, the bituminous stream in conduit 126 comprises less than about 5, less than about 2, or less than 1 weight percent water and/or less than about 2, less than about 1, or less than 0.5 weight percent solids, based on the total weight of the bituminous stream. Upgrader 20 thermally and/or catalytically cracks the heavy hydrocarbon molecules in the bituminous stream into carbon (i.e., “coke”) and hydrocarbon vapor stream in conduit 128, which is subjected to further processing (not shown) to ultimately be converted into syncrude and other petroleum products.

As mentioned previously, the tailings streams in conduits 110, 114, and 124 comprise recoverable hydrocarbon components, including bitumen. In one embodiment, each stream entering the tailings pond 22 can comprise greater than about 5 weight percent, greater than about 10 weight percent, greater than about 25 weight percent, or greater than 35 weight percent recoverable hydrocarbon components, based on the total weight of the stream. According to the embodiment shown in FIG. 1, to recover the residual bitumen, a stream comprising water, hydrocarbon, and solid particles can be withdrawn from tailings pond 22 via conduit 130 and routed through filter 30 to remove at least a portion of the solid particles prior to entering the suction of pump 32. Pump 32 increases the pressure of the two-phase stream, which is discharged into conduit 132 and thereafter split into two portions. The first portion is routed via conduit 134 through an additional filter 34 prior to flowing via conduit 136 into a TSRU flash drum 26, which will be discussed in further detail below. In one embodiment, the stream in conduit 136 comprises in the range of from about 0.001 to about 0.1, about 0.005 to about 0.075, or 0.009 to 0.060 weight percent solid particles, based on the total weight of the stream.

According to one embodiment illustrated in FIG. 1, the second portion of the two-phase hydrocarbon containing stream discharged from pump 32 can be routed via conduit 132 into the inlet of heat exchanger 36. Generally, the temperature of the stream entering the inlet of heat exchanger 36 can be greater than about 4° C. or in the range of from about 5 to about 30° C., or 6 to 25° C. The temperature of the stream exiting the outlet of heat exchanger 36 via conduit 138 can be in the range of from about 50 to about 300° C., about 75 to about 275° C., or 80 to 250° C. Heat exchanger 36 can be operable to vaporize at least a portion of the two-phase stream in conduit 138. In one embodiment, the resulting three-phase stream in conduit 138 can have a vapor fraction greater than about 0.5, or in the range of from about 0.6 to about 0.98, or 0.7 to 0.95, on a weight basis based on the total weight of the stream. In another embodiment, the liquid fraction of the stream in conduit 138 can be less than about 0.25, less than about 0.10, less than about 0.05, or less than about 0.01, on a weight basis based on the total weight of the stream. The solid particles in the stream in conduit 138 generally comprise sand, clay, silica, mineral solids, dirt, asphaltenes, and the like. Typically, about 90 percent of the solid particles have an average particle size less than about 500 microns, less than about 200 microns, less than about 150 microns, or less than 110 microns. Generally, the three-phase stream in conduit 138 can comprise in the range of from about 0.001 to about 1, about 0.005 to about 0.75, or 0.01 to 0.5 weight percent solid particles, based on the total weight of the stream.

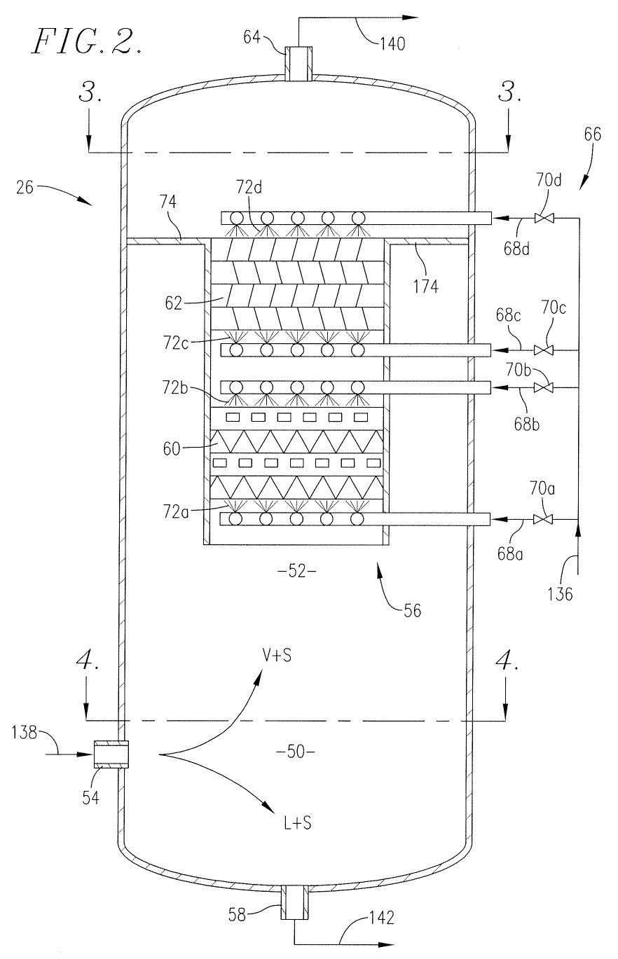

Referring back to the embodiment shown in FIG. 1, the three-phase feed stream in conduit 138 can be routed into the lower portion of TSRU flash drum 26. Generally, the operating temperature of TSRU flash drum 26 can be at least about 1° C., at least about 2° C., or at least 5° C. below the bubble point temperature of water at the vessel operating pressure. The operating temperature of TSRU flash drum 26 can be in the range of from about 50 to about 300° C., about 75 to about 275° C., 80 to about 250° C., or 85 to about 150° C. The operating pressure of TSRU flash drum 26 can be in the range of from about 50 to about 400 kilopascals (kPa), about 100 to about 300 kPa, or about 150 to about 250 kPa. The specific configuration of TSRU flash drum 26 will be discussed in greater detail below with reference to FIG. 2.

As illustrated in FIG. 1, TSRU flash drum 26 separates the hydrocarbon containing feed stream in conduit 138 into a predominantly vapor stream in conduit 140 and a predominantly liquid stream in conduit 142. The aqueous, predominantly liquid stream enters the suction of pump 38 and is thereafter discharged into conduit 148. The predominantly vapor hydrocarbon containing stream, which comprises in the range of from about 0 to about 50, about 0.5 to about 40, or 1 to 30 parts per million by weight (ppmw) solids, can be routed via conduit 140 into the inlet of heat exchanger 40, wherein the stream is cooled and at least partially condensed. The resulting stream in conduit 140 can then enter solvent stripping column 28, wherein the stream is separated into a predominantly vapor stream and a predominantly liquid stream, which enter respective conduits 142 and 144. The predominantly vapor stream in conduit 142 comprising recovered hydrocarbon (i.e., bitumen, solvent, and other components) can be routed for further processing and/or reuse. The predominantly liquid stream in conduit 144 enters the suction of pump 42 and is subsequently discharged into conduit 146, whereafter the stream combines with the aqueous predominantly liquid stream in conduit 148 discharged from pump 38. The combined aqueous stream in conduit 150 can then be routed back to tailings pond 22 for subsequent reclamation.

Referring now to FIG. 2, one embodiment of the TSRU flash drum 26 of the present invention is generally illustrated as comprising a substantially cylindrical, vertically elongated vessel having a vapor-liquid separation zone 50 and a vapor-solid separation zone 52. In order to facilitate separation of solid particles from the ascending vapor stream, vapor-solid separation zone 52 can be located at a higher elevation than the vapor-liquid separation zone 50, as illustrated in FIG. 2.

Referring again to FIG. 2, the three-phase stream in conduit 138 can flow through fluid inlet 54 of TSRU flash drum 26 and can discharge into vapor-liquid separation zone 50, wherein the stream can be separated into a particulate-containing vapor portion and a particulate-containing liquid portion. The particulate-containing liquid portion can flow to the bottom of TSRU flash drum 26 and can subsequently be withdrawn through liquid outlet 58 into conduit 142. As discussed previously, the liquid stream in conduit 142 can then be routed to tailings pond 22 in FIG. 1 for subsequent reclamation. As illustrated in FIG. 2, the particulate-containing vapor stream exits vapor-liquid separation zone 50 and ascends into vapor-solid separation zone 52.

Vapor-solid separation zone 52 comprises a solids flow inhibiting structure 56. Solids flow inhibiting structure 56 can be any device operable to cause the removal of solid particles from the ascending vapor stream. In one embodiment of the present invention, solids flow inhibiting structure 56 can have a particulate removal efficiency of at least about 75 percent, at least about 90 percent, at least about 95 percent, or at least 99 percent. As used herein, the term “particulate removal efficiency” of a structure can be defined by the following equation: (total mass of solid particles entering the structure−total mass of solid particles exiting the structure)/(total mass of solid particles entering the structure), expressed as a percentage.

According to one embodiment illustrated in FIG. 2, solids flow inhibiting device 56 can comprise a first separation zone 60 and a second separation zone 62. First separation zone 60 can have a particulate removal efficiency of greater than about 50 percent, greater than about 75 percent, or greater than 80 percent. Second separation zone 62 can have a particulate removal efficiency of greater than about 90 percent, greater than about 95 percent, greater than about 98 percent, or greater than 99 percent. Generally, first separation zone 60 can be operable to remove solid particles of a size that would cause erosion in downstream equipment (i.e., solid particles with average particle sizes greater than about 50 microns), while second separation zone 62 can be operable to remove smaller particles commonly attributed to fouling and/or plugging of downstream equipment (i.e., solid particles with an average particle size less than about 50 microns). In one embodiment, first separation zone 60 can have a particulate removal efficiency of at least about 75, at least about 90, at least about 95, at least about 98, or at least 99 percent for solid particles having an average particle size of greater than about 50 microns. In another embodiment, second separation zone 62 can have a particulate removal efficiency of at least about 90, at least about 95, at least about 98, or at least 99 percent for solid particles having an average particle size of about 50 microns or less. Generally, the predominantly vapor stream exiting vapor outlet 64 of TSRU flash drum 26 via conduit 140 can comprise in the range of from about 0 to about 50, about 0.5 to about 40, or 1 to 30 parts per million by weight (ppmw) solids. As a result, TSRU flash drum 26 can have average maintenance intervals that are at least about 1.5, at least about 2, or at least about 3 times longer than the average maintenance intervals of conventional TSRU flash drums.

According to one embodiment of the present invention, solids flow inhibiting structure 56 can comprise packing. The type, characteristics, and configuration of the packing employed in solids flow inhibiting structure 56 can generally be determined according to the level of severity of the solids service. For example, structured packing can be employed in severe erosion and plugging environments, such as oil sand tailings removal. As illustrated in the embodiment shown in FIG. 2, first separation zone 60 can comprise grid structured packing having a specific surface area less than about 17 square feet per cubic foot (ft²/ft³), less than about 14.5 ft²/ft³, or less than 13 ft²/ft³. Examples of grid structured packing suitable for use in the present invention can include, but are not limited to, EF-25A Grid and FLEXIGRID® #2, #3, and #4 (both available from Koch-Glitsch, LP in Wichita, Kans.). In another embodiment of the present invention, second separation zone 62 can comprise corrugated structured packing having a specific surface area less than about 35 ft²/ft³, less than about 33.5 ft²/ft³, or less than 30 ft²/ft³. In one embodiment, corrugated structured packing can include vane-type mist eliminators. Suitable corrugated structured packings can include, but are not limited to, FLEXICHEVRON® and FLEXIPAC® (both available from Koch-Glitsch, LP in Wichita, Kans.). Corrugated structured packing such as, for example, FLEXIPAC® 3X, 3Y, and/or 4Y may also be employed in first packing section 60 in applications wherein the quantity and/or average size of the particles to be separated can pass through the packing without plugging.

The height of the packing in each separation zone 60 and 62 generally depends on the quantity and particle size distribution of the solid particles in the ascending vapor stream. As an example, the height of first separation zone 60 can be at least about 24 inches, at least about 30 inches, at least about 36 inches, or at least 48 inches. The height of second separation 62 zone can be in the range of from about 2 to about 30 inches, about 4 to about 24 inches, or 6 to 18 inches. Generally, second separation zone is desirably located at a higher elevation than first separation zone 60. According to one embodiment, second separation zone can be located at least about 24 inches, at least about 30 inches, or at least 36 inches above first separation zone 60.

As illustrated in FIG. 2, solids flow inhibiting structure 56 can additionally comprise a spray device 66 operable to wet at least a portion of the packing in first and second separation zones 60 and 62 with a process liquid. Wetting packing encourages solid particles in the ascending vapor stream to adhere to the packing surface and form particulate agglomerates, which increase in size and density until they are sloughed off the packing surface and fall to the bottom of TSRU flash drum 26. Generally, the volume, rate, and distribution of process liquid exiting spray device 66 can depend on the amount, particle size distribution, and fouling tendency of the solid particles in the ascending vapor stream.

Turning now to the specific configuration of spray device 66 illustrated in one embodiment of the present invention presented in FIG. 2, a process liquid enters spray device 66 via conduit 136. The process liquid in conduit 136 can be filtered water originating from tailings pond 22 shown in FIG. 1. In another embodiment, the process liquid can be any water stream comprising in the range of from about 0.001 to about 0.1, about 0.005 to about 0.075, or 0.009 to 0.060 weight percent solids based on the total weight of the stream, such as, for example, boiler feed water. As shown in FIG. 2, spray device 66 can comprise multiple spray healers 68a-d and each spray header 68 can comprise a plurality of spray nozzles 72. Generally, the number, size, and distribution of the spray nozzles can depend on the vessel diameter, packing depth, or other similar characteristics of TSRU flash drum 26. In one embodiment, each spray header can comprise at least about 2, at least about 4, or at least about 6 spray nozzles. In order to prevent plugging, the open area of the nozzles should be greater than about 0.25 inches, greater than about 0.375 inches, or greater than 0.5 inches. To provide sufficient coverage and prevent plugging of the packed sections due to liquid maldistribution, the spray nozzles should provide at least about 100 percent, at least about 150 percent, or at least 200 percent coverage of the packing. Generally, the pressure operating range of the spray nozzles can be in the range of from about 1 to about 50 psi, about 2 to about 30 psi, or 5 to 20 psi.

At least a portion of the spray nozzles can be oriented to wet both the upper and lower portions of packing in first and second separation zones 60 and 62. For example, in one embodiment, upper spray headers 68b and 68d can each comprise at least one downwardly oriented spray nozzle 72b and 72d, respectively, operable to wet at least a portion of the respective packing in first and second separation zones 60 and 62. Similarly, in another embodiment, lower spray headers 68a and 68c include at least one respective upwardly oriented spray nozzle 72a and 72c operable to wet at least a portion of the packing in first and second separation zones 60 and 62, respectively. It may be advantageous to redistribute the flow rate of the process liquid in spray headers 68a-d by adjusting valves 70a-d in order to optimize particulate removal. In one embodiment of the present invention, the average volumetric flow rate of process liquid through upper spray header 68b of first separation zone 60 can be at least about 1.5, at least about 2, or at least 2.5 times greater than the average volumetric flow rate of process liquid through lower spray header 68a of first separation zone 60. Generally, the volumetric flow rate of process liquid through upper spray header 68b can be in the range of from about 0.1 to about 100, about 0.15 to about 75, or 0.2 to 50 gallons per minute per square foot of packing area (gpm/ft²). The volumetric flow rate of process liquid to lower spray header 68a can be in the range of from about 0.1 to about 20, about 0.15 to about 10, or 0.2 to 1 gpm/ft². In another embodiment, the average process liquid volumetric flow rate through lower spray header 68c of second separation zone 62 can be at least about 1.25, at least about 1.40, or at least about 1.5 times greater than the average volumetric flow rate of process liquid through upper spray header 68d of second packing zone 62. In general, the volumetric flow rate of process liquid through lower spray header 68c can be in the range of from about 0.1 to about 100, about 0.5 to about 75, or 1 to 50 gpm/ft². The flow rate of process liquid to upper spray header 68d can be in the range of from about 0.01 to about 1, about 0.1 to about 0.75, or 0.2 to about 0.5 gpm/ft². In accordance with one embodiment wherein the solid particles in the ascending vapor stream have a minimal fouling tendency, at least one of the spray headers 68a-d can be operated on an intermittent basis.

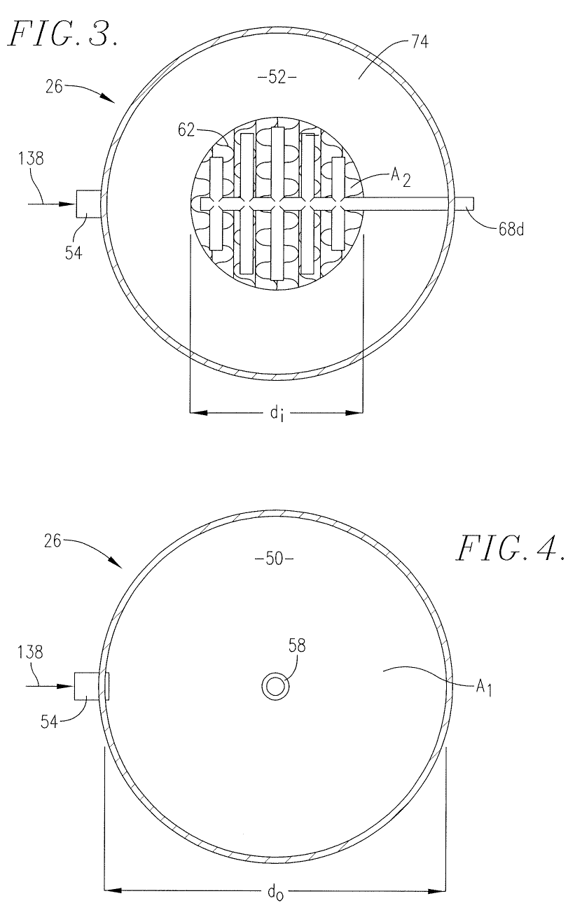

Referring now to FIGS. 3 and 4, the average cross-sectional flow area A₂ of vapor-solid separation zone 52 can be in the range of from about 5 to 80 percent, about 10 to about 75 percent, or 20 to 60 percent of the average cross-sectional flow area A₁ of vapor-liquid separation zone 50. When TSRU flash drum 26 comprises a substantially cylindrical vessel, as illustrated in FIG. 2, the average cross-sectional flow area A₂ of vapor-solid separation zone 52 can be reduced by reducing the diameter of that zone. In one embodiment, reducing the external diameter, dₒ, Of the upper portion of TSRU flash drum 26 can effectively reduce the diameter of vapor-solid separation zone 52. In another embodiment illustrated in FIGS. 3 and 4, a vapor flow inhibiting device 74 (i.e., a shroud) can be installed in vapor-solid separation zone 52 to effectively reduce the internal diameter, dᵢ, while the external diameter of vapor-solid separation zone, dₒ, can remain the same as vapor-liquid zone diameter. The former embodiment may be advantageous for newly constructed projects, while the latter embodiment may be more suitable for use in retrofitting existing equipment.

Although the present invention has been described with reference to its application in the removal of oil sands tailings particulates from a vapor stream, it should be understood that the present invention could be suitable for use in any application wherein solid removal from a three-phase stream is desired. In one embodiment, the present invention can be employed in other locations within an oil sands processing facility, such as, for example, a bitumen pre-flash drum (not shown) upstream of the upgrader. In another embodiment, the present invention can be utilized in oil shale processing to separate rock and/or shale particulates from a three-phase stream.

The following Example illustrates the solid particle removal ability of one embodiment of the present invention, and is not intended to limit the scope of the invention in any way.

### EXAMPLE

Two samples of a vapor stream containing oil sand tailings particulates from a TSRU flash drum in an oil sands processing facility were analyzed to determine the bulk composition and particle size distribution of the tailings particulates. The bulk composition was determined via Dean Stark analysis and the normalized results are presented in Table 1, below. Results for particle size distribution, determined by Malvern laser technique, are presented in Table 2, below.

TABLE 1
Normalized Bulk Composition for Oil Sand Tailings Samples

| | Asphaltenes, | Water, | Mineral Solids, | Total, |
|---|---|---|---|---|
| Sample | wt % | wt % | wt % | wt % |
| 1 | 33.12 | 0 | 66.88 | 100 |
| 2 | 23.49 | 0 | 76.51 | 100 |
| Average | 28.31 | 0 | 71.70 | 100 |

TABLE 2
Particle Size Distribution Data for Oil Sand Tailings Samples

| | D10 | D50 | | <2 | <10 | <44 | <74 |
|---|---|---|---|---|---|---|---|
| Sam- | (mic- | (mic- | D90 | microns | microns | microns | microns |
| ple | rons) | rons) | (microns) | (%) | (%) | (%) | (%) |
| 1 | 8.3 | 47.9 | 137.7 | 2 | 12 | 47 | 69 |
| 2 | 9.2 | 53.0 | 149.6 | 2 | 11 | 43 | 64 |
| Average | 8.8 | 50.4 | 143.6 | 1.9 | 11.5 | 45.0 | 66.5 |

A simulation of the TSRU flash drum was conducted using a computerized on routine. In the simulation, the TSRU flash drum was modeled to include a 49-inch tall section of FLEXIGRID® packing located 40 inches below a 12-inch section of FLEXICHEVRON® packing. The FLEXIGRID® packing had a specific surface area of 12.8 ft²/ft³ the FLEXICHEVRON® packing had a specific surface area of 33 ft²/ft³ and an element spacing of 0.75 inches. The upper portion of the TSRU flash drum was modeled to have a reduced cross-sectional flow area of 13.13 m² (i.e., a diameter of 4.09 m), compared to the lower portion of the drum, which had a cross-sectional flow area of 78.54 m² (i.e., a diameter of 10 m).

The simulated TSRU also included spray headers above and below each packing section. Table 3 below summarizes the average volumetric flow rates in cubic meters per hour (m³/h) to each spray header.

TABLE 3
Average Volumetric Flow Rates to Spray Headers in Simulation

| | | | Average Volumetric |
|---|---|---|---|
| Spray Header | | | Flow Rate, |
| Location | Orientation | Packing Section | m³/h |
| upper | downward | FLEXICHEVRON ® | 12.8 |
| lower | upward | FLEXICHEVRON ® | 19.2 |
| upper | downward | FLEXIGRID ® | 72.0 |
| lower | upward | FLEXIGRID ® | 24.0 |

During the simulation, a stream comprising solid particles according to the above bulk composition and particle size distribution was subjected to separation in the above-described packing configuration. The simulation results showed a 95 percent decrease in tailings particles having an average particle size greater than about 40 microns and a 99.9 percent overall decrease in the solid particle content of the overhead vapor stream.

From the foregoing, it will be seen that this invention is one well adapted to attain all the ends and objectives hereinabove set forth, together with other advantages which are inherent to the structure.

It will be understood that certain features and subcombinations are of utility and may be employed without reference to other features and subcombinations. This is contemplated by and is within the scope of the claims.

Since any possible embodiments may be made of the invention without departing from the scope thereof, it is to be understood that all matter herein set forth or shown in the accompanying drawings is to be interpreted as illustrative and not in a limiting sense.

What is claimed is:

1. A method for separating solid particles from a two-phase stream, said method comprising the steps of:
(a) heating at least a portion of a two-phase stream comprising a liquid and a plurality of solid particles to thereby produce a three-phase stream having a vapor fraction greater than about 0.5, on a weight basis based on the total weight of the stream;
(b) separating said three-phase stream in a vapor-liquid separation zone of a separation vessel into a particulate-containing liquid stream and a particulate-containing vapor stream; and
(c) introducing said particulate-containing vapor stream into an overlying vapor-solid separation zone in said separation vessel and separating at least a portion of said solid particles from said vapor stream as said particulate-containing vapor stream passes through a solids flow inhibiting structure in said vapor-solid separation zone.

2. The method of claim 1, wherein said introducing of step (c) comprises introducing said particulate-containing vapor stream into a vapor-solid separation zone having an average cross-sectional flow area in the range of from about 5 to about 80 percent of the average cross-sectional flow area of said vapor-liquid separation zone.

3. The method of claim 1, including, prior to said heating of step (a), withdrawing a portion of said two-phase stream and routing said portion to said vapor-solid separation zone to wet at least a portion of said solids flow inhibiting structure.

4. The method of claim 1, wherein said introducing of step (c) comprises passing said particulate-containing vapor stream through a solids flow inhibiting structure having a particulate removal efficiency of at least about 75 percent.

5. The method of claim 1, wherein said heating of step (a) comprises producing a three-phase stream having in the range of from about 0.001 to about 1 weight percent of said solid particles, based on the total weight of the three-phase feed stream.

6. The method of claim 1, wherein said introducing of step (c) comprises passing said particulate-containing vapor stream through a solids flow inhibiting structure comprising structured packing.

7. The method of claim 6, wherein said step of passing said particulate-containing vapor stream through a solids flow inhibiting structure comprises passing said particulate-containing vapor stream through a solids flow inhibiting structure comprising a first packed section and an overlying second packed section.

8. The method of claim 7, wherein said step of passing said particulate-containing vapor stream through a solids flow inhibiting structure comprises passing said particulate-containing vapor stream through a solids flow inhibiting structure comprising a first packed section comprising grid packing.

9. The method of claim 8, wherein said step of passing said particulate-containing vapor stream through a solids flow inhibiting structure comprises passing said particulate-containing vapor stream through a solids flow inhibiting structure comprising grid packing having a specific surface area less than about 17 square feet per cubic foot (ft²/ft³).

10. The method of claim 7, wherein said step of passing said particulate-containing vapor stream through a solids flow inhibiting structure comprises passing said particulate-containing vapor stream through a solids flow inhibiting structure comprising a second packed section comprising corrugated packing.

11. The method of claim 10, wherein said step of passing said particulate-containing vapor stream through a solids flow inhibiting structure comprises passing said particulate-containing vapor stream through a solids flow inhibiting structure comprising corrugated packing having a specific surface area less than about 35 ft²/ft³.

12. The method of claim 7, including, passing at least a portion of said feed stream through said first packed section having a particulate removal efficiency of at least about 75 percent for solid particles having an average particle size of greater than about 50 microns to thereby produce a first particulate-depleted vapor stream.

13. The method of claim 12, including, passing at least a portion of said first-particulate depleted vapor stream through said second packed section having a particulate removal efficiency of at least about 90 percent for solid particles having an average particle size of about 50 microns or less to thereby produce a second particulate-depleted vapor stream.

14. The method of claim 7, wherein said introducing of step (c) comprises introducing said particulate-containing vapor stream into an overlying vapor-solid separation zone in a separation vessel comprising a first lower spray header comprising at least one upwardly oriented spray nozzle to wet at least a portion of said second packing section with a process liquid, wherein said first lower spray header is located an elevation above said first packing section and below said second packing section.

15. The method of claim 14, wherein said introducing said particulate-containing vapor stream into said vapor-solid separation zone in said separation vessel comprises introducing said particulate-containing vapor stream into said vapor-solid separation zone in a separation vessel comprising a second upper spray header comprising at least one downwardly oriented spray nozzle to wet at least a portion of said first packing section with a process liquid, wherein said second upper spray header is located at an elevation above said first packing section and below said second packing section.

16. The method of claim 15, wherein said introducing said particulate-containing vapor stream into said vapor-solid separation zone in said separation vessel comprises introducing said particulate-containing vapor stream into said vapor-solid separation zone in a separation vessel comprising a third lower spray header comprising at least one upwardly oriented spray nozzle operable to wet at least a portion of said first packed section and/or a fourth upper spray header comprising at least one downwardly oriented spray nozzle operable to wet at least a portion of said second packed section, wherein said third lower spray header is located at an elevation below said first packed section, wherein said fourth upper spray header is located at an elevation above said second packed section.

17. The method of claim 16, including, passing said process liquid to said second upper spray header at an average volumetric flow rate that is at least about 1.5 times greater than the average volumetric flow rate of said process liquid to said third lower spray header.

18. The method of claim 16, including, passing said process liquid to said first lower spray header at an average volumetric flow rate that is at least about 1.25 times greater than the average volumetric flow rate of said process liquid to said fourth upper spray header.

19. The method of claim 16, including, operating at least one spray nozzle on an intermittent basis.

20. The method of claim 16, wherein said process liquid comprises water from an oil sand tailings pond.

21. The method of claim 1, wherein the temperature of said separation vessel is at least about 1° C. below the bubble point temperature of water at the operating pressure of said separation vessel.

22. A method for separating solid particles from a three-phase hydrocarbon containing stream, said method comprising:
(a) subjecting at least a portion of a three-phase hydrocarbon containing stream comprising a plurality of solid particles to separation in a separation vessel to thereby produce a first particulate-containing vapor stream and a second particulate-containing liquid stream;
(b) withdrawing at least a portion of said second particulate-containing liquid stream from said separation vessel via a liquid outlet located in a lower portion of said separation vessel;
(c) passing said first particulate-containing vapor stream through a first separation zone comprising a first structured packing section located in an upper portion of said separation vessel to thereby produce a first particulate-depleted vapor stream;
(d) simultaneously with step (c), wetting said first structured packing section with a process liquid;
(e) passing said first particulate-depleted vapor stream through a second separation zone comprising a second structured packing section to thereby produce a second particulate-depleted vapor stream; and
(f) simultaneously with step (e), wetting said structured packing with a process liquid,
wherein said three-phase hydrocarbon containing stream has a vapor fraction greater than about 0.5, on a weight basis based on the total weight of the stream,
wherein the average cross-sectional flow area of said upper portion of said separation vessel is in the range of from about 5 to about 80 percent of the average cross-sectional flow area of said lower portion of said separation vessel.

23. The method of claim 22, wherein said passing of step (c) comprises passing said first particulate-containing vapor stream through a first separation zone comprising a first structured packing section having a particulate removal efficiency of greater than about 75 percent.

24. The method of claim 22, wherein said passing of step (c) comprises passing said first particulate-containing vapor stream through a first separation zone comprising a first structured packing section having a particulate removal efficiency of greater than about 90 percent for solid particles having an average particle size greater than about 50 microns.

25. The method of claim 22, wherein said passing of step (e) comprises passing said first particulate-depleted vapor stream through a second separation zone comprising a second structured packing section having a particulate removal efficiency of greater than about 95 percent for solid particles having an average particle size of about 50 microns or less.

26. The method of claim 22, wherein said subjecting of step (a) comprises subjecting at least a portion of a three-phase feed stream comprising in the range of from about 0.001 to about 1 weight percent of said solid particles, based on the total weight of the stream.

27. The method of claim 22, wherein said wetting of steps (d) and/or (f) is at least partially accomplished by passing said process liquid through at least one upwardly oriented spray nozzle.

28. The method of claim 27, wherein said wetting of steps (d) and/or (f) is at least partially accomplished by passing said process liquid through at least one downwardly oriented spray nozzle.

29. The method of claim 28, including, operating at least one spray nozzle on an intermittent basis.

30. The method of claim 22, wherein said passing of step (c) comprises passing said first particulate-containing vapor stream through said first separation zone comprising a first structured packing section comprising grid packing having a specific surface area less than about 17 ft²/ft³.

31. The method of claim 22, including, prior to step (a), heating a two-phase stream comprising solid particles to thereby produce said three phase hydrocarbon containing stream.

32. The method of claim 31, including, prior to heating said two-phase, withdrawing a portion of said two-phase stream and using at least a portion of the withdrawn stream as said process liquid in steps (d) and/or (f).

33. The method of claim 22, wherein said process liquid comprises water from an oil sand tailings pond.

34. The method of claim 22, wherein said solid particles comprise oil sand particulates.

35. An apparatus for separating oil sands particulates from a three-phase stream, said apparatus comprising:
a vertically oriented separation vessel comprising a vapor-solid separation zone and an underlying vapor-liquid separation zone, wherein the average cross-sectional flow area of said vapor-solid separation zone is in the range of from about 5 to about 80 percent of the average cross-sectional flow area of said vapor-liquid separation zone;
a feed inlet in said separation vessel for introducing a three-phase stream into said vapor-liquid separation zone;
a liquid outlet in said separation vessel for withdrawing a predominantly liquid stream from said vapor-liquid separation zone;
a vapor outlet in said separation vessel for withdrawing a predominantly vapor stream from said vapor-solid separation zone;
a solids flow inhibiting structure located in said vapor-solid separation zone, wherein said solids flow inhibiting structure comprises a first structured packing section and an overlying second structured packing section;
at least one lower spray header comprising at least one upwardly oriented spray nozzle located at a higher elevation than said first structured packing section and a lower elevation than said second structured packing section and operable to wet at least a portion of said second structured packing section; and
at least one upper spray header comprising at least one downwardly oriented spray nozzle located at a higher elevation than said first structured packing section and a lower elevation than said second structured packing section and operable to wet at least a portion of said first structured packing section.

36. The apparatus of claim 35, including, a heat exchanger located upstream of said separation vessel operable to at least partially vaporize a two-phase stream to thereby provide said three-phase feed stream.

37. The apparatus of claim 36, including, a conduit located upstream of said heat exchanger operable to withdraw a portion of said two-phase stream and route said portion to said separation vessel.

38. The apparatus of claim 35, including, at least one lower spray header comprising at least one upwardly oriented spray nozzle located at an elevation below said first structured packing section, wherein said at least on upwardly oriented spray nozzle is operable to wet at least a portion of said first packing section.

39. The apparatus of claim 40, including, at least one upper spray header comprising at least one downwardly oriented spray nozzle located at an elevation above said second packing section, wherein said at least one downwardly oriented spray nozzle is operable to wet at least a portion of said second packing section.

40. The apparatus of claim 35, wherein said overlying second structured packing section is located at least about 24 inches above said first structured packing section.

41. The apparatus of claim 35, wherein said first structured packing section has a height of at least about 24 inches.

42. The apparatus of claim 35, wherein said second structured packing section has a height in the range of from about 2 to about 24 inches.

43. The apparatus of claim 35, wherein said first structured packing section comprises grid packing having a specific surface area less than about 17 ft²/ft³.

44. The apparatus of claim 35, wherein said second structured packing section comprises corrugated packing having a surface area less than about 35 ft²/ft³.
